(19) United States
(12) Patent Application Publication
(10) Pub. No.: US 2026/0178469 A1
(43) Pub. Date: Jun. 25, 2026

(54) SYSTEMS AND METHODS FOR APPLICATION RESILIENCY ENHANCEMENT

(71) Applicant: The PNC Financial Services Group, Inc., Pittsburgh, PA (US)

(72) Inventors: Michael NITSOPOULOS, Pittsburgh, PA (US); Palamayuran SURENTHIRAN, Pittsburgh, PA (US)

(73) Assignee: The PNC Financial Services Group, Inc., Pittsburgh, PA (US)

(21) Appl. No.: 19/316,547

(22) Filed: Sep. 2, 2025

Related U.S. Application Data
(63) Continuation of application No. 19/204,190, filed on May 9, 2025.
(60) Provisional application No. 63/736,500, filed on Dec. 19, 2024.

(51) Int. Cl. G06F 11/362; G06F 11/07; H04L 9/32

(52) U.S. Cl. CPC G06F 11/362; G06F 11/0766; H04L 9/3213

(57) ABSTRACT

Systems and methods for enhancing application resiliency are provided. Some embodiments involve receiving an issue correction request from an application. Some embodiments involve sending an authentication token request to an authentication server and receiving an authentication token. Some embodiments involve creating a synthetic monitor instance in response to receiving the authentication token. In some embodiments, the synthetic monitor instance invokes a microservices instance that detects an application error. In some embodiments, the synthetic monitor instance creates a message. In some embodiments, the synthetic monitor instance sends the message to a service operations manager. In some embodiments, the service operations manager invokes an information technology solutions router. In some embodiments, the information technology solutions router requests a runbook. In some embodiments, the information technology solutions router invokes the runbook to respond to the issue correction request.

The present application claims priority to U.S. Provisional Application No. 63/736,500, filed on Dec. 19, 2024, the contents of which are incorporated herein by reference.

The present disclosure relates generally to systems and methods designed to enhance application resiliency. Application resiliency may refer to an application's ability to continue operations in compliance with the application's goals despite events that may conflict with those goals.

Application resiliency may be enhanced by automatic error monitoring and handling, which may be performed by the application itself or another application responsible for responding to application errors across one or more applications.

Some embodiments involve receiving an issue correction request including an event detail element and an application identifier from an application associated with the application identifier. Some embodiments involve sending, in response to receiving the issue correction request, an authentication token request to an authentication server. Some embodiments involve receiving an authentication token in response to the authentication token request from the authentication server. Some embodiments involve creating a synthetic monitor instance in response to receiving the authentication token. In some embodiments, the synthetic monitor instance is configured to invoke a microservices instance configured to detect an application error. In some embodiments, the synthetic monitor instance is configured to, in response to detecting the application error, create a service operations management payload message including the event detail element, the application identifier, and an application purpose identifier. In some embodiments, the synthetic monitor instance is configured to send the service operations management payload message to a service operations manager. In some embodiments, the service operations manager is configured to invoke an information technology solutions router in response to receiving the service operations management payload message. In some embodiments, the information technology solutions router is configured to request, from a database, a runbook based on the event detail element, the application identifier, and the application purpose identifier. In some embodiments, the information technology solutions router is configured to invoke the runbook to respond to the issue correction request.

Some embodiments involve receiving a synthetic monitor creation request including a synthetic monitor configuration file. Some embodiments involve creating a synthetic monitor in response to the request, the synthetic monitor associated with one or more code elements based on the synthetic monitor configuration file. Some embodiments involve receiving one or more synthetic monitor provision elements based on the synthetic monitor configuration file. Some embodiments involve updating the synthetic monitor based on the one or more synthetic monitor provision elements. Some embodiments involve receiving a request to promote or enhance the one or more code elements. Some embodiments involve promoting or enhancing the synthetic monitor configuration file in response to the request. Some embodiments involve creating a promoted synthetic monitor in response to the promotion, the promoted synthetic monitor including one or more promoted synthetic monitor code elements.

### BRIEF DESCRIPTION OF FIGURES

The accompanying drawings, which are incorporated in and constitute a part of this specification, illustrate disclosed embodiments and, together with the description, serve to explain the disclosed embodiments.

FIG. 1 shows an exemplary system having an application requiring improved resilience, consistent with disclosed embodiments.

FIG. 2 shows an exemplary system capable of executing an application with resilience, consistent with disclosed embodiments.

FIG. 3 shows an exemplary system dedicated to improving application resilience, consistent with disclosed embodiments.

FIG. 4 shows an exemplary computing device dedicated to improving application resilience, consistent with disclosed embodiments.

FIG. 5 shows an exemplary process for improving application resilience, consistent with disclosed embodiments.

FIG. 6 shows an exemplary process that may be performed by an exemplary synthetic monitor, consistent with disclosed embodiments.

FIG. 7 shows an exemplary process that may be performed by an exemplary service operations manager and/or an exemplary information technology solutions router, consistent with disclosed embodiments.

FIG. 8 shows an exemplary process for improving application resilience, consistent with disclosed embodiments.

FIG. 9 shows an exemplary system capable of improving application resilience, consistent with disclosed embodiments.

FIG. 10 shows an exemplary system capable of improving application resilience, consistent with disclosed embodiments.

FIG. 11 shows an exemplary system capable of improving application resilience, consistent with disclosed embodiments.

FIG. 12 shows an exemplary system capable of improving application resilience, consistent with disclosed embodiments.

### DETAILED DESCRIPTION

Reference will now be made in detail to exemplary embodiments, discussed with reference to the accompanying drawings. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be implemented and that changes may be made without departing from the scope of the disclosed embodiments. For example, unless otherwise indicated, method steps disclosed in the figures may be rearranged, combined, or divided without departing from the envisioned embodiments. Phrases that tend to indicate an order of events, such as “before,” “prior to,” then,” “after,” and the like are not intended to be limiting. Similarly, additional steps may be added, or steps may be removed, without departing from the envisioned embodiments. Thus, the materials, methods, and examples are illustrative only and are not intended to be necessarily limited.

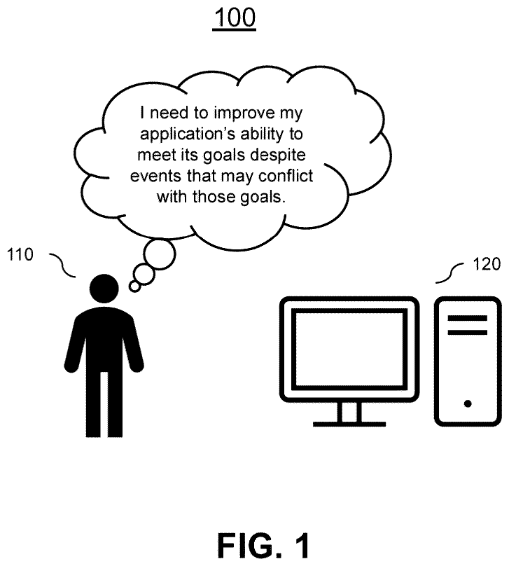

Referring to FIG. 1, an exemplary system environment 100 is shown according to disclosed embodiments. System environment 100 may include an administrator 110 and a computer 120 hosting an application. The administrator 110 may express a desire to improve their application's ability to meet its goals despite events that may conflict with those goals, such as events impacting code operation, events causing application down time, events causing race conditions, code change requests, etc.

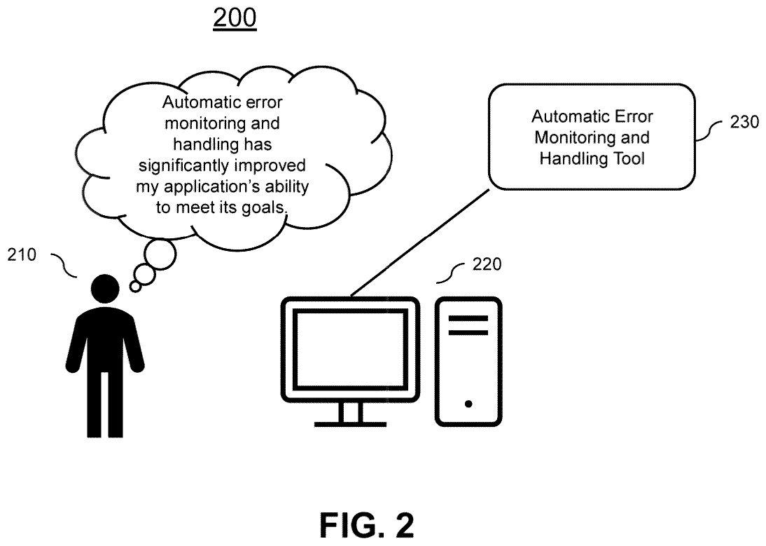

Turning to FIG. 2, an exemplary system environment 200 is shown according to disclosed embodiments. System environment 200 may include an administrator 210, a computer 220 hosting an application, and an automatic error monitoring and handling tool 230. In some embodiments, the automatic error monitoring and handling tool 230 may be used to enhance application resilience. For example, the automatic error monitoring and handling tool 230 may be used to respond to events impacting code operation; prevent or respond to application down time; prevent, detect, or respond to race conditions; respond to code change requests; etc.

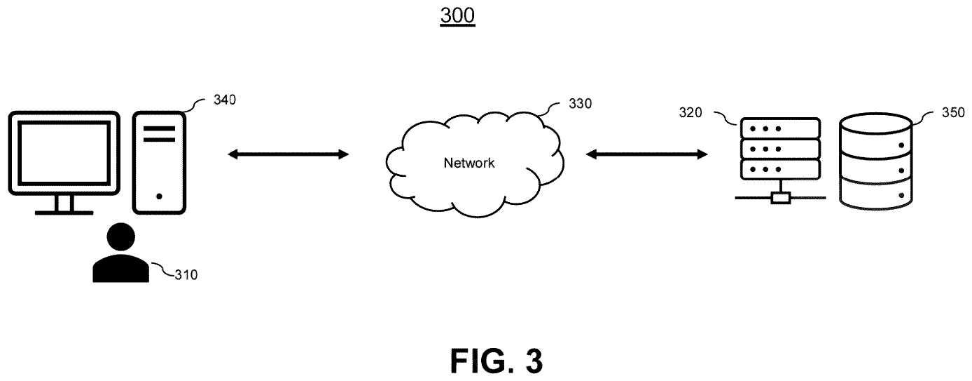

Referring to FIG. 3, an exemplary system environment 300 is disclosed, consistent with disclosed embodiments. System environment 300 may include one or more endpoint devices 340, which may be operated by administrator 310, which may correspond to administrator 210. System environment 300 may further include one or more computing devices 320, a network 330, and one or more databases 350.

The various components of system environment 300 may communicate over a network 330. Such communications may take place across various types of networks, such as the Internet, a wired Wide Area Network (WAN), a wired Local Area Network (LAN), a wireless WAN (e.g., WiMAX), a wireless LAN (e.g., IEEE 802.11), a mesh network, a mobile/cellular network, an enterprise or private data network, a storage area network, a virtual private network using a public network, a nearfield communications technique (e.g., Bluetooth, infrared), or various other types of network communications. In some embodiments, the network communications may take place across two or more of these forms of networks and protocols. While system environment 300 is shown as a network-based environment, it is understood that in some embodiments, one or more aspects of the disclosed systems and methods may also be used in a localized system, with one or more of the components communicating directly with each other.

Computing device 320 may include any form of remote computing device configured to receive, store, and transmit data. For example, computing device 320 may be a server configured to store files accessible through a network (e.g., a web server, application server, virtualized server, etc.). Computing device 320 may interact with a database 350, for example, a loan information database, to receive and/or store information. Database 350 may be included on a volatile or non-volatile, magnetic, semiconductor, tape, optical, removable, non-removable, or other type of storage device or tangible or non-transitory computer-readable medium. Database 350 may also be part of computing device 320 or separate from computing device 320. When database 350 is not part of computing device 320, computing device 320 may exchange data with database 350 via a communication link. Database 350 may include one or more memory devices that store data and instructions used to perform one or more features of the disclosed embodiments. Database 350 may include any suitable databases, ranging from small databases hosted on a work station to large databases distributed among data centers. Database 350 may also include any combination of one or more databases controlled by memory controller devices (e.g., server(s)) or software. For example, database 350 may include document management systems, Microsoft SQL™ databases, SharePoint™ databases, Oracle™ databases, Sybase™ databases, other relational databases, or non-relational databases, such as mongo and others. Although one database 350 is shown in FIG. 3, the system environment 300 may include one or more databases 350, which may be used to store various types of information associated with customers of a financial institution.

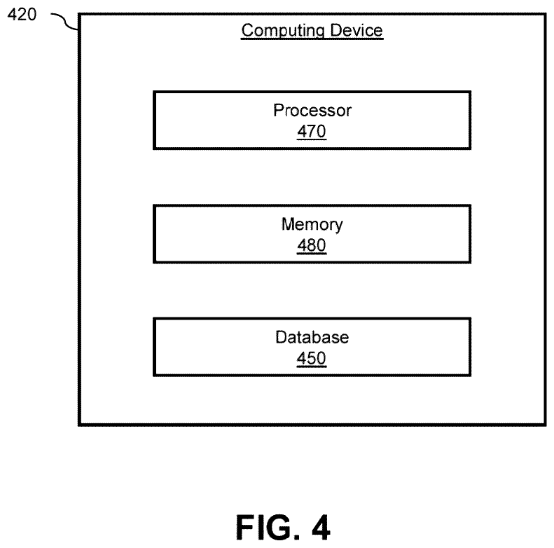

FIG. 4 is a block diagram showing an example computing device 420, which may correspond to computing device 320 from FIG. 3, consistent with the disclosed embodiments. As described above, computing device 420 may be one or more devices configured to allow data to be received and/or transmitted by system environment 300 (e.g., a server) and may include one or more dedicated processors and/or memories. For example, computing device 420 may include a processor (or multiple processors) 470, a memory (or multiple memories) 480, and a database 450, which may correspond to database 350 shown in FIG. 3. Computing device 420 may include one or more digital and/or analog devices that may allow computing device 420 to communicate with other machines and devices, such as other components of system 300 shown in FIG. 3. Computing device 420 may include one or more input/output devices. Computing device 420 may include a screen for displaying communications to a user. In some embodiments computing device 420 may include a touch screen. Computing device 420 may include other components known in the art for interacting with a user. Computing device 420 may also include one or more digital and/or analog devices that may allow a user to interact with system 300, such as touch-sensitive area, keyboard, buttons, or microphones.

Processor 470 may take the form of, but is not limited to, one or more integrated circuits (IC), including application-specific integrated circuit (ASIC), microchips, microcontrollers, microprocessors, embedded processor, all or part of a central processing unit (CPU), graphics processing unit (GPU), digital signal processor (DSP), field-programmable gate array (FPGA), server, virtual server, system on an chip (SOC) or other circuits suitable for executing instructions or performing logic operations. Furthermore, according to some embodiments, processor 470 may be from the family of processors manufactured by Intel®, AMD®, Qualcomm®, Apple®, NVIDIA®, or the like. The processor 470 may also include a mobile processor, a graphics processing unit, etc. The disclosed embodiments are not limited to any type of processor configured in computing device 420. In some embodiments, processor 470 may be a special purpose processor configured to perform one or more of the operations described below.

Memory 480 may include one or more storage devices configured to store instructions used by the processor 470 to perform functions related to computing device 420. The disclosed embodiments are not limited to particular software programs or devices configured to perform dedicated tasks. For example, the memory 480 may store a single program, such as a user-level application, that performs the functions associated with the disclosed embodiments or may include multiple software programs. Additionally, the processor 470 may, in some embodiments, execute one or more programs (or portions thereof) remotely located from computing device 420. Furthermore, memory 480 may include one or more storage devices configured to store data for use by the programs. Memory 480 may include, but is not limited to a hard drive, a solid-state drive, a CD-ROM drive, a peripheral storage device (e.g., an external hard drive, a USB drive, etc.), a network drive, a cloud storage device, or any other storage device.

Computing device 420 may include a database 450 as described above. Database 450 may also be part of computing device 420 or separate from computing device 420. In some embodiments, computing device 420 may include one or more input/output devices, communications devices, displays, and/or other interfaces (e.g., server-to-server, database to-to-database, or other network connections). One or more of endpoint devices 340 may include components similar to those discussed with respect to computing device 420 and may perform functions similar to or different from those described above with respect to computing device 420.

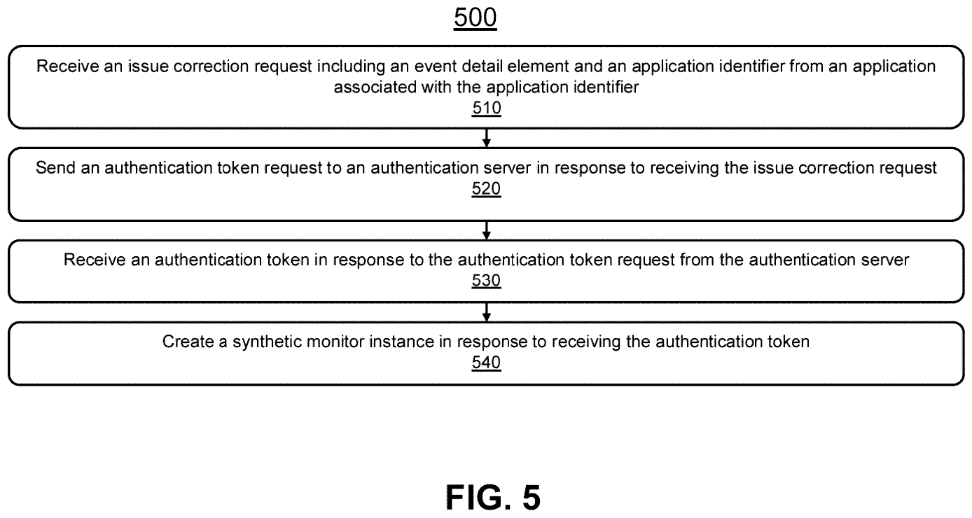

Referring to FIG. 5, an exemplary process 500 for coordinated monitoring is disclosed, according to disclosed embodiments. At step 510, some embodiments may involve receiving an issue correction request including an event detail element and an application identifier from an application associated with the application identifier. The issue correction request may be a bug report or error report and may be sent from a developer or as part of an error reporting process associated with an application. The event detail element may refer to an error code associated with a bug report or error report. In some embodiments, the error code may allow an error handling system such as a runbook to resolve the issue in response to the issue correction request, when supplied with additional information about the issue. In some embodiments, a runbook may be configured so that it can automatically respond to one or more system errors using an automated response. For example, a runbook designed to fix an application's non-responsiveness due to insufficient resources may do so by allocating more resources to the application. As another example, the runbook may be designed to investigate or interpret the reason for the insufficient resources. For example, insufficient resources caused by a directed denial of service (DDOS) attack may not be fixed by allocating additional resources to the application. Instead, the runbook may be configured to cut off application access by one or more sources of the DDOS attack, which may prevent the attacker from seizing control of resources while allowing other users ongoing access to resources. The application identifier may refer to an application name, which may be descriptive of the application's purpose or may include an alphanumeric identifier. In some embodiments, the application identifier may be used by the error handling system to resolve the issue if, for example, the issue or the resolution is specific to a given application. For example, a potential cure for issues relating to access to sensitive user data or funds may differ from a potential cure for issues relating to access to a public-facing website. Potential cures may be tailored to the expected extent of traffic using a given application or the sensitivity of information associated with the application.

At step 520, some embodiments involve sending, in response to receiving the issue correction request, an authentication token request to an authentication server. The authentication server may be a third-party server or may be controlled by the same entity as the entity sending the authentication token request or the same entity as the entity receiving the issue correction request. In some embodiments, the authentication server may be a separate server or may be the same server that hosts one or more other software elements, such as the application or the error handling system. At step 530, some embodiments may further involve receiving an authentication token in response to the authentication token request from the authentication server. In some embodiments, the authentication server requires identity validation in connection to the authentication token request before sending the authentication token. The identity validation may be performed based on authentication elements such as single-sign on, two-factor authentication, username and password, digital identity authentication, or the like.

At step 540, some embodiments may involve creating a synthetic monitor instance in response to receiving the authentication token. In some embodiments, a synthetic monitor instance may be a use case of a synthetic monitor. For example, a synthetic monitor instance may be directed to monitoring a single application or a series of applications for a single issue. In some embodiments, a synthetic monitor instance is capable of monitoring many applications for many potential issues and may be capable of delegating one or more responsibilities associated with diagnosing, addressing, curing, and/or reporting an issue.

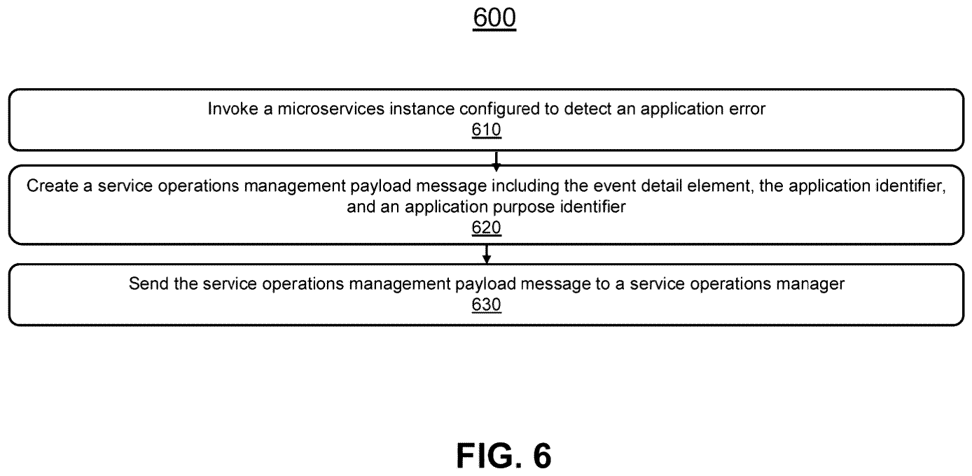

Turning to FIG. 6, an exemplary process 600 is described according to some embodiments. Process 600 may be performed by the synthetic monitor instance created at step 540 of FIG. 5. At step 610, in some embodiments, the synthetic monitor instance may be configured to invoke a microservices instance configured to detect an application error. The application error may refer to a user-or developer-reported bug, a feature request, or a detected code error. The microservices instance may be configured to automatically detect application errors by receiving bug reports or feature requests or by working with debugging software to detect errors. In some embodiments, the microservices instance may use machine learning to monitor code associated with the application to detect code indicative of an application error.

A machine learning algorithm may be trained to detect code indicative of an application error by providing training data in the form of code to a machine learning algorithm capable of reading and interpreting the code. Some of the code may have produced an error when executed. The machine learning algorithm may be directed to associate one or more code elements from the training data with the execution errors during the training process. Additional training data in the form of additional code may then be input into the machine learning algorithm. A subset of the additional code may also have produced an error when executed, but the machine learning algorithm may not be advised which code produced an error. The machine learning algorithm may be instructed to output a guess of which code produced an error, and the machine learning algorithm's output may be corrected based on which code produced an error. After training, the machine learning algorithm may be capable of predicting whether code will produce an error before the code has produced the error.

At step 620, in some embodiments, the synthetic monitor instance may be further configured to, in response to detecting the application error, create a service operations management payload message including the event detail element, the application identifier, and an application purpose identifier. The service operations management payload message may include further information elements specific to the detected application error or the application. Information elements specific to the detected application error may include a description of the error, an identifier associated with the error or a class of errors, and/or metadata associated with the error. In the case of a DDOS attack, for example, the information elements may include an approximate number of active requests, an IP address associated with a significant portion of active requests, etc. Information elements specific to the application may include one or more elements identifying the application; one or more elements placing the application into the context of a class of applications; and/or information about the application that may be used during issue resolution, such as, for example, the expected traffic for the application and whether the application handles sensitive data. In some cases, one or more information elements included with the service operations management payload message may include a null value. At step 630, in some embodiments, the synthetic monitor instance may be further configured to send the service operations management payload message to a service operations manager. In some embodiments, the service operations manager may be an object or process responsible for delegation of service operations, as described herein.

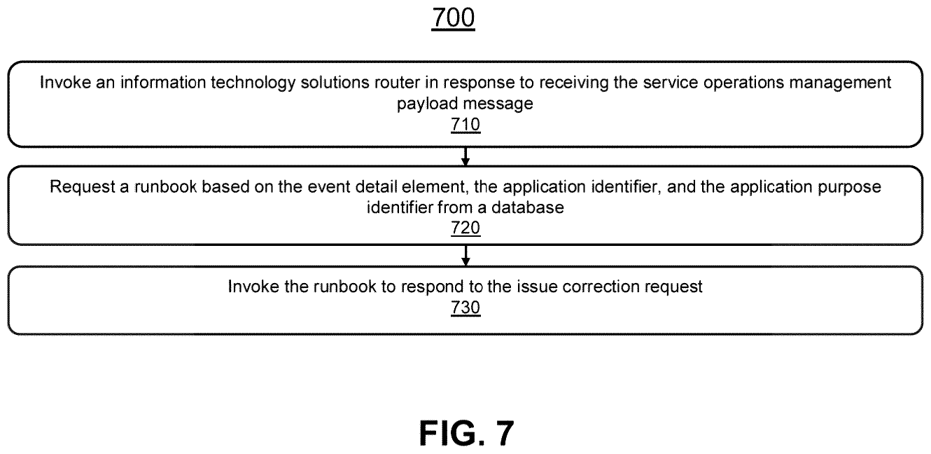

Turning to FIG. 7, an exemplary process 700 is described according to some embodiments. Process 700 may be performed by the service operations manager that may be configured to receive the service operations management payload message at step 630 of FIG. 6. At step 710, in some embodiments, the service operations manager may be configured to invoke an information technology (IT) solutions router in response to receiving the service operations management payload message. In some embodiments, the IT solutions router may be configured to continuously monitor the application, allowing the IT solutions router to detect common IT issues and either resolve the IT issues or refer the common IT issues to a department capable of resolving the IT issues. Automated monitoring and IT issue resolution may enhance resiliency by automating detection and resolution of issues that may negatively impact resiliency, especially if left unaddressed for an extended time. In some embodiments, the IT solutions router may be a collection of software tools providing related monitoring and/or issue resolution services.

At step 720, in some embodiments, the information technology solutions router may be configured to request, from a database, a runbook based on the event detail element, the application identifier, and the application purpose identifier. The runbook may be configured to respond to the issue correction request based on the event detail element, the application identifier, and the application purpose identifier.

At step 730, in some embodiments, the information technology solutions router may be further configured to invoke the runbook to respond to the issue correction request. In some embodiments, the runbook may be tailored to the issue correction request based on the information elements included in the service operations management payload message. The runbook may be pre-programmed with one or more instructions dedicated to fixing application errors. In some cases, the instructions may be specific to the event detail element. In other words, classes of application errors may be grouped based on error type, and a single runbook or group of runbooks may be dedicated to each group of errors. The runbook or group of runbooks may be selected based on the event detail element, the application identifier, and the application purpose identifier, or some combination of the three. In some embodiments, the runbook may be selected based only on the event detail element, but the runbook's solution to the application error may be dictated by the application identifier and/or the application purpose identifier. In some embodiments, runbooks may be automatically generated, may be created based on one or more set of pre-existing criteria, or may be created along with criteria. The criteria may be associated with an error that the runbook is designed to solve and/or may be built based on one or more service level agreements (SLAs). For example, a runbook criteria may be designed such that the runbook requires that an application be in operation at least a percentage of time, based on an SLA. Invocation of a runbook may lead to automatic error monitoring and handling for applications, as disclosed in embodiments described herein.

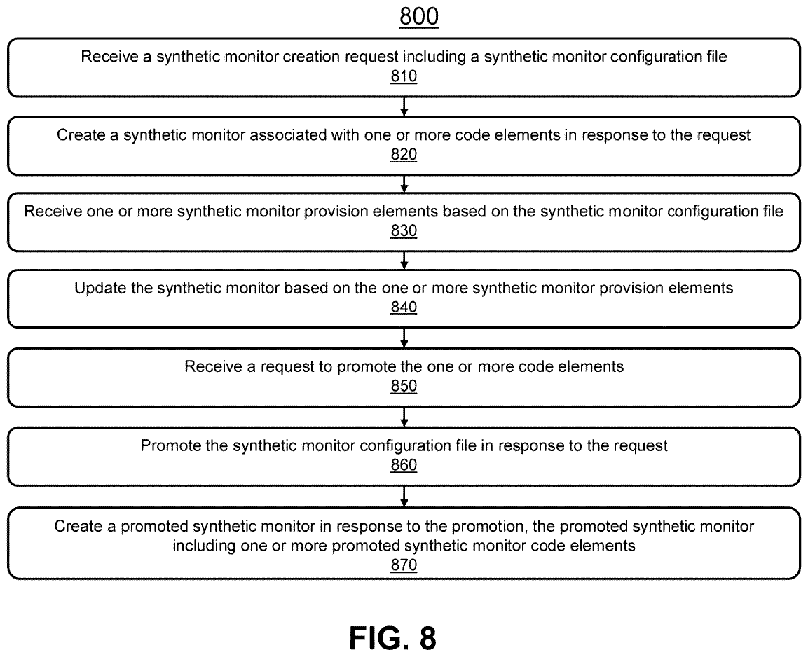

Turning to FIG. 8, an exemplary process 800 for coordinated monitoring is disclosed according to disclosed embodiments. At step 810, some embodiments associated with the present disclosure may involve receiving a synthetic monitor creation request including a synthetic monitor configuration file. In some embodiments, an application developer may send the synthetic monitor creation request, while in other embodiments, an automated process may send the synthetic monitor creation request in connection to application development or in connection to ongoing application runtime. Some embodiments implement both synthetic monitor creation request methods at different points in time.

At step 820, some embodiments involve creating a synthetic monitor in response to the request. In some embodiments, the synthetic monitor may be associated with one or more code elements. The synthetic monitor may be created to automatically monitor applications for ongoing compliance with system requirements, automatically monitor for bugs, automatically monitor for downtime, or automatically monitor for feature update requests. In some embodiments, the synthetic monitor may be configured to receive notice of one or more events that may indicate an application error, such as, for example, non-compliance with one or more system requirements, a software bug, application downtime, or feature update requests. In some embodiments, the synthetic monitor may be configured to respond to one or more application errors by creating alerts associated with the application errors, by calling one or more applications configured to fix the application errors, and/or by containing code configured to fix the errors. Synthetic monitoring may improve application resiliency by improving response time to application errors. In some embodiments, a single synthetic monitor may be associated with a single application or may be associated with multiple applications. A single synthetic monitor associated with more than one application may be associated with the applications based on related subject matter of the applications or may be associated with all applications associated with an organization. The one or more code elements may be associated with one or more of the applications and may be configured to run with an application. In some embodiments, the code elements may cause an application to run.

At step 830, some embodiments may involve receiving one or more synthetic monitor provision elements, which may be based on the synthetic monitor configuration file. Provisioning a synthetic monitor may refer to testing the synthetic monitor using simulated user interactions with an application associated with the synthetic monitor. The simulated user interactions may involve test cases, test scripts, and scheduled tests, which may be configured to test application capacity during high-performance time periods.

At step 840, some embodiments may involve updating the synthetic monitor based on the one or more synthetic monitor provision elements. Updating the synthetic monitor may involve revising one or more previously provisioned elements for the synthetic monitor, may involve re-testing the synthetic monitor using simulated user interactions, may involve populating, for the first time, provisioned elements for the synthetic monitor, or may involve testing the synthetic monitor for the first time. Re-testing the synthetic monitor may be performed in response to the addition of one or more synthetic monitor tests, which may be associated with one or more anticipated or unanticipated user actions. In some cases, unexpected user behavior may prompt the creation of additional tests, and the synthetic monitor may need to be updated according to the additional tests. In some embodiments, testing synthetic monitor functionality may have been previously infeasible, cost prohibitive, time prohibitive, or low priority. In such instances, factors leading to infeasibility, cost prohibition, time prohibition, or low priority may have changed, which may lead to the introduction of additional tests.

In some embodiments, resiliency testing may involve proactively identifying “top offender” applications that may not conform to resiliency standards. Exemplary “top offenders” may include outage of a service, failure of a dependent service, saturation of resources beyond specified limits, etc. Testing may involve identification of a monitor able to identify and correct the offender. Testing may involve setting up an alert system based on certain criteria. For example, a failed synthetic monitor check may result in the generation of an alert. In some embodiments, the generation of an alert will trigger one or more runbook tools, which may employ steps to maintain service availability and resiliency. Execution of the runbook tools may be automatic or manual.

At step 850, some embodiments may involve receiving a request to promote or otherwise enhance the one or more code elements. Promoting or enhancing the one or more code elements may involve moving application code through code review tiers. The code review tiers may include quality assurance (QA), user acceptance testing (UAT), or production. It may be desirable to have synthetic monitoring services active throughout promotions through code review tiers. Thus, at step 860, some embodiments may involve promoting or enhancing the synthetic monitor configuration file in response to the request. At step 870, some embodiments involve creating a promoted or enhanced synthetic monitor in response to the promotion. In some embodiments, the promotion or enhancing may occur such that the code elements and synthetic monitor are promoted or enhanced at the same time in response to a single promotion or enhancement request, so that the synthetic monitor may operate in coordination with the code review tier. In some embodiments, the synthetic monitor may be re-provisioned based on the promotion to include new testing requirements corresponding to each code review tier. In some embodiments, the promoted or enhanced synthetic monitor may include one or more promoted or enhanced synthetic monitor code elements. The enhanced promoted or enhanced synthetic monitor may then be placed into operation.

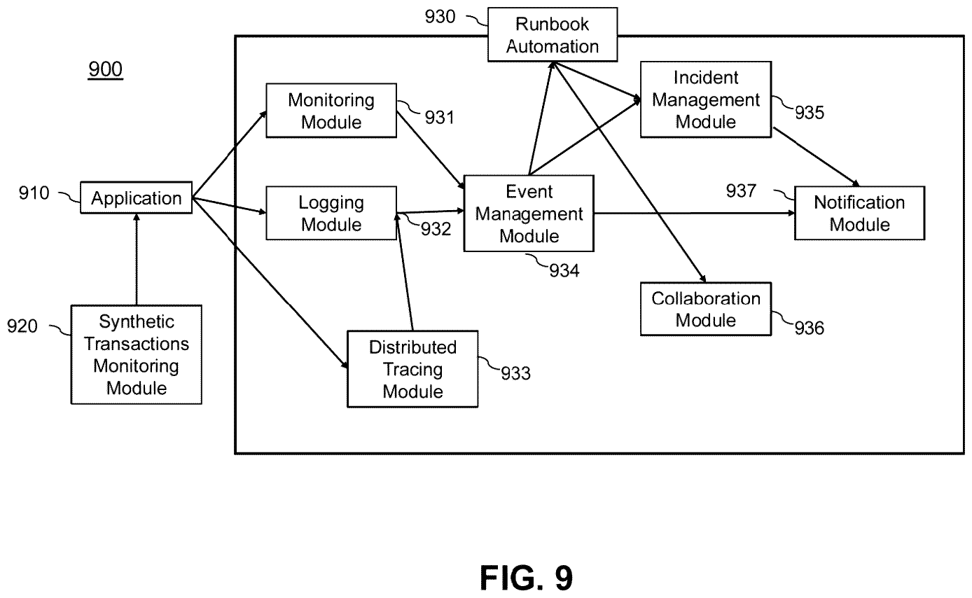

Turning to FIG. 9, exemplary system environment 900 may be used to improve the resiliency of an application 910. Application resiliency may be enhanced using automated application monitoring and troubleshooting, which may be included within runbook automation module 930. In some embodiments, automated application monitoring and troubleshooting may involve using one or more components that support application monitoring and troubleshooting. For example, integration of a platform directed to software observability, such as synthetic transactions monitoring module 920 and monitoring module 931, may provide application monitoring capabilities to ensure application resiliency in the face of adverse events.

As another example, the use of a stack of software solutions that may involve one or more of a search and analytics engine, a data processing pipeline that may operate in electronic communication with the search and analytics engine, and a visualization layer that may operate in electronic communication with the search and analytics engine may provide support for logging application events. Logging application events, such as through a logging module 932, may facilitate troubleshooting and/or confirmation of compliance with one or more resiliency requirements. As yet another example, use of a distributed tracing module 933 may allow for active monitoring of requests to and from an application, facilitating debugging efforts and allowing for the detection of vulnerabilities. Application resiliency may be enhanced as a result of such debugging efforts and/or detection of vulnerabilities.

In some embodiments, monitoring module 931 and logging module 932 may be configured to detect errors associated with an event. An error may include a service interruption or unexpected/unwanted software functionality. An event may refer to a user's interaction with the system, whether synthetic or otherwise. In some embodiments, monitoring module 931 and logging module 932 may respond to detected errors by referring the detected errors to a system, service, or module configured to prevent service outages and improve incident management, such as event management module 934. Such a system, service, or module may be designed to automate incident management or correlate events and errors. In some embodiments, such a system, service, or module may be designed to provide insights regarding errors to promote or improve error resolution.

As a further example, synthetic transactions may need to be run and managed to coordinate testing of software systems and updates to those software systems resulting from the testing. In some embodiments, a module, such as incident management module 935 may be employed to run and manage synthetic transactions. In some embodiments, the same module may be used to direct change management and incident management, which may be used to respond to change requests or errors.

As another example, error correction and responses to change requests may involve collaboration within and across development teams. Collaboration may include propagation of automated or manual messages directed to resolving the errors and change requests. The collaboration may involve one or more runbooks dedicated to error correction and/or responses to change requests. In some embodiments, collaboration may be performed on a platform such as collaboration module 936. Collaboration module 936 may permit discussions among or across teams through various communication media, including text, voice, video, etc.

As yet another example, information technology (IT) software may provide for the automated resolution of common IT issues by allowing software to assist with the diagnosis and treatment of certain known or predictable issues. In some embodiments, the IT software may continuously monitor the application, allowing the IT software to detect common IT issues and either resolve the IT issues or refer the common IT issues to a department capable of resolving the IT issues. Automated monitoring and IT issue resolution may enhance resiliency by automating detection and resolution of issues that may negatively impact resiliency, especially if left unaddressed for an extended time. In some embodiments, the IT software may be a collection of software tools providing related monitoring and/or issue resolution services.

As another example, a notification module 937 may be implemented to report the status of monitoring and troubleshooting solutions. In some embodiments, the notification module 937 may involve a dashboard configured to display one or more reported monitoring and troubleshooting solutions to a user device through a graphical user interface. The dashboard may involve providing separate status display windows to the user, each status display window configured to present status information associated with one or more software tools designed for automated monitoring and troubleshooting.

In some embodiments, automated monitoring and troubleshooting may be enhanced by the combination of several separate automated monitoring and troubleshooting tools into a single framework designed for automated monitoring and troubleshooting. Combining tools into a single framework may enhance application resiliency across applications by allowing several applications access to a suite of tools known to enhance resiliency by facilitating error correction and event handling.

Steps to enhance application resiliency may further involve preparation of standards, guidelines, and best practices for applications and may involve building code frameworks based on defined standards and policies. In some embodiments, architectural patterns may be employed that are configured to improve application resiliency. In such embodiments, an architectural pattern may be employed that is configured to include modules designed to embed and standardize error handling and resiliency patterns according to disclosed embodiments. Resilient patterns may include resource limitations, redundancy, and rate limiting. In some embodiments, resiliency enhancement depends on compliance with operational limits, such as maximum memory and disk space, and may include requirements that HTTP/socket/database connections be defined and compared with an expected load. In some embodiments, resiliency enhancement depends on compliance with redundancy requirements, such as the development of a fallback strategy with a corresponding solution in the event a platform cannot meet its goals.

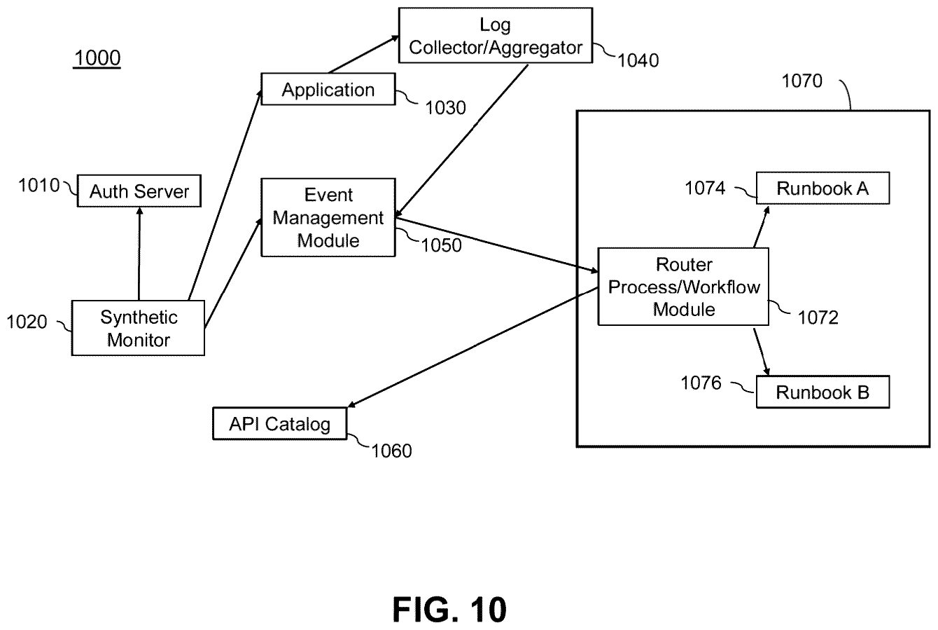

Turning to FIG. 10, exemplary system environment 1000 may be used to improve application resiliency. According to some embodiments, application resiliency may be improved using one or more synthetic monitors, such as synthetic monitor 1020. Synthetic monitor 1020 may be configured to request an authentication token, which may be an OAUTH token, from an authentication server, such as authentication server 1010. The request may involve providing one or more authentication credentials, such as a username, password, key, or biometric identifier. In some embodiments, the authentication server 1010 is configured to receive and validate the authentication credentials before returning the authentication token.

In some embodiments, the synthetic monitor 1020 may use the authentication token to invoke an endpoint of an application, such as application 1030. In some embodiments, application 1030 may be configured as an orchestrator and may be configured to detect and/or monitor for errors to enhance application resiliency. The endpoint may be a URL used in connection to one or more monitors based on the synthetic monitor's environment. The URL may be provided in connection to a given synthetic monitor and may be supplied during configuration of the synthetic monitor. In some embodiments, the endpoint is a microservices endpoint. Microservices may refer to subsets of functionality designed to be self-contained, so as to not interfere with the functionality of other microservices. A microservices instance, as used herein, may refer to a single microservice or a group of microservices. Code describing a microservice may be capable of creating one or more microservices instances.

If the application 1030 detects an error, it may be configured to generate a payload event, which may be sent to a system, service, or module configured to configured to prevent service outages and improve incident management, such as event management module 1050. Such a system, service, or module may be designed to automate incident management or correlate events and errors. In some embodiments, such a system, service, or module may be designed to provide insights regarding errors to promote or improve error resolution.

In some embodiments, the event management module 1050 may be configured to discern which, if any, router to invoke in response to the payload event. In response to the discerning, the event management module 1050 may invoke the router it has discerned, which may be a router process/workflow module 1072 within an orchestrator 1070. The router process/workflow module 1072 may use error content included in its invocation to look up a runbook mapping. The lookup may involve requesting the runbook mapping from an API catalog, such as API catalog 1060, which may be an object and/or a database responsible for storing, distributing, and managing runbook mappings. In some embodiments, the router process/workflow module 1072 may send to the API catalog 1060 an error code, an error type, an application name, and/or an application purpose identifier to the API catalog 1060. In response, the API catalog 1060 may look up a runbook endpoint, which the API catalog 1060 may then send to the router process/workflow module 1072 in response to the request. In some embodiments, the error code cannot be mapped to a runbook.

In some embodiments, in response to receiving a runbook endpoint, the router process/workflow module 1072 may invoke a runbook associated with the runbook endpoint, such as one or both of runbook A 1074 and runbook B 1076. In some embodiment, the runbook may operate to correct the error or make the requested change. In some embodiments, the runbook cannot fix the error or make the requested change. In such cases, a new runbook may be created to address the error or change, or the error or change may be addressed manually.

In some embodiments, a logging framework may keep a log of software interactions, which may include tracking synthetic transactions. In some embodiments, an application, such as application 1030, may monitor for errors in the log. In some embodiments, the errors may be errors that are not handled by application code. In some embodiments, the application 1030 may be configured to request that a log collector/aggregator 1040 collect log events associated with the error. The log events, which may be stored as syslogs, may be stored in one or more database, which may include one or more encryption elements to ensure security of the log events. In some embodiments, the log events may be viewed through a an aggregated view.

In some embodiments, the log collector/aggregator 1040 is configured to create an event based on detection of a specific error. In some embodiments, the errors are detected using a filter, which may be
{match(‘logger\“:\”com.dev’ value(“MESSAGE”)) and match(‘level\“: \”ERROR’ value(“MESSAGE”)) and match(“errorCode” value (“MESSAGE”)); };

In some embodiments, the logger may have a sub string value of “com.dev.” This may ensure that only logs narrowed to a logging framework are filtered. In some embodiments, the level may have a substring value of “ERROR.” This may ensure that only log errors are filtered. In some embodiments, the errorCode is presented in the message. The value of errorCode may be defaulted as errorCode=ERR9999 if the developer has not assigned an error code to the error condition. This may ensure that only specific errors are filtered.

In some embodiments, the event management module 1050 may invoke a router, such as router process/workflow module 1072 within orchestrator 1070. In some embodiments, the event management module 1050 is configured to pass to the router process/workflow module 1072 an error code, application identifier, application name, and detailed log message. In some embodiments, the router process/workflow module 1072 may be configured to pass the error code, application identifier, application name, and detailed log message to a runbook, such as runbook A 1074 or runbook B 1076. In some embodiments, the runbook may take action based on the error code and the detailed log message. In some embodiments, no ticket is created in response to monitoring the log. In such embodiments, the runbook may be retried, or additional runbooks may be tried, in order to address the error. A ticket may be created to address the error or a change request. In some embodiments, the event invocation by the event management module 1050 may stop once the error no longer emits in the log.

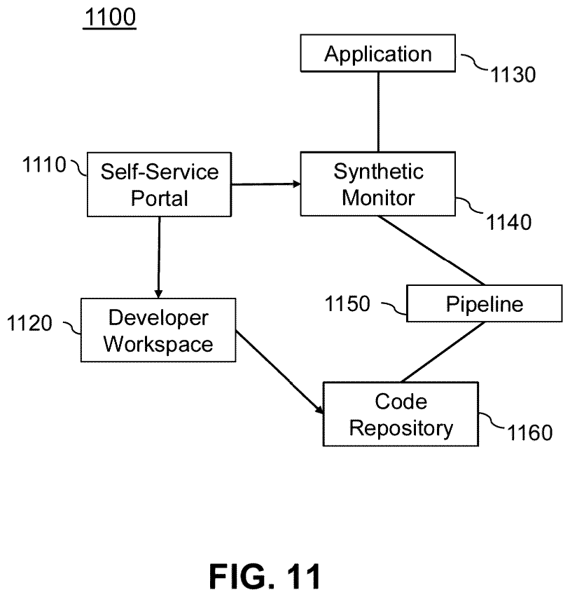

Turning to FIG. 11, an exemplary system environment 1100 is disclosed. In some embodiments, system environment 1100 may include a portal, such as self-service portal 1110, which may include a synthetic monitor model configured to facilitate the creation of a synthetic monitor using one or more provisioning attributes. The self-service portal 1110 may include a configuration (config) file and be described in a synthetic monitor provision file containing the provisioning attributes. The config file may contain details about the synthetic monitor, such as a monitor identifier, a group identifier, and an endpoint. The config file may be used by application code to retrieve information about the synthetic monitor. In some embodiments, a workspace such as developer workspace 1120 may be used to commit the synthetic monitor provision file to render the synthetic monitor active.

In some embodiments, a synthetic monitor, such as synthetic monitor 1140, may be created from the config file and the synthetic monitor provision file. The synthetic monitor 1140 may be associated with an application, such as application 1130. In some embodiments, a continuous integration/continuous delivery/deployment pipeline (CI/CD pipeline), such as pipeline 1150, may be used to provision the synthetic monitor using the config file. Continuous integration may refer to code being compiled, tested, packaged, and sent to an artifactory as a deployable and/or downloadable unit. In some embodiments, CI may occur once in each iteration or for each code change. Continuous delivery/deployment may refer to a binary and/or image from the CI stage being pulled in, approved, and deployed in an associated environment, tested after deployment, and marked as a success or rolled back based on testing feedback. In some embodiments, code associated with the synthetic monitor 1140 may be promoted or enhanced based on a code repository, such as code repository 1160. The synthetic monitor config file may also be promoted or enhanced along with the code, and may be promoted or enhanced at the same rate as the code. In some embodiments, the synthetic monitor may then be created using the config file for the environment endpoint where the code was promoted or enhanced.

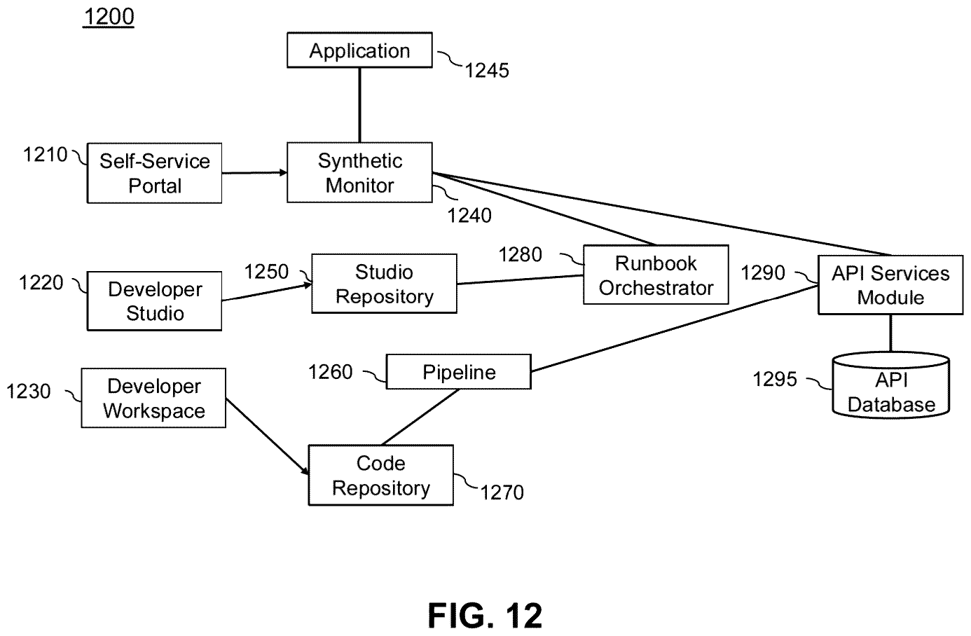

Turning to FIG. 12, an exemplary system environment 1200 is disclosed. In some embodiments, system environment 1200 may include a portal, such as self-service portal 1210, which may include a synthetic monitor model configured to facilitate the creation of a synthetic monitor, such as synthetic monitor 1240, using one or more provisioning attributes. In some embodiments, system environment 1200 may include a studio, such as developer studio 1220, which may include a design workflow, a test workflow, and an export workflow, which may be used to design, test, and export runbooks. In some embodiments, the developer studio 1220 may be used to develop a runbook using an orchestrator studio. The runbook may be stored in a repository, such as studio repository 1250. In some embodiments, system environment 1200 may include a workspace, such as developer workspace 1230, which may include a compose error mapping file and a commit error mapping file. In some embodiments, the developer workspace 1230 may be used to develop and check a mapping file, which may be used to map the runbook to an application.

System environment 1200 may include a CI pipeline, such as pipeline 1260, which may be configured to load the runbook mapping file into a centralized catalog repository, such as API database 1295. In some embodiments, one or more services, such as API services module 1290, may be invoked to load the centralized catalog repository and may include a validate error catalog and a load/save error catalog. In some embodiments, code associated with the synthetic monitor 1240 may be promoted or enhanced based on a code repository, such as code repository 1270. The synthetic monitor config file may also be promoted or enhanced along with the code, and may be promoted or enhanced at the same rate as the code. In some embodiments, the synthetic monitor may then be created using the config file for the environment endpoint where the code was promoted or enhanced.

In some embodiments, the synthetic monitor 1240 may be associated with an application, such as application 1245, and may be configured to create an event and pass the event, with an associated runbook context, to API services module 1290. In some embodiments, the synthetic monitor may include pre/post scripts configured to invoke an orchestrator, such as runbook orchestrator 1280, which may use the associated runbook context to invoke a specific runbook, from the studio repository 1250, to respond to the error event.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions that implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions that execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which includes one or more executable instructions for implementing the specified logical function(s). It should also be noted that, in some alternative implementations, the functions noted in the block may occur out of the order noted in the figures. Some steps may be deleted, added, or modified. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

1-20. (canceled)

21. A computer readable medium storing instructions that, when executed by one or more processors, cause the one or more processors to perform operations comprising:
receiving a synthetic monitor creation request, including a synthetic monitor configuration file;
creating a synthetic monitor in response to the request, the synthetic monitor associated with one or more code elements based on the synthetic monitor configuration file;
receiving one or more synthetic monitor provision elements based on the synthetic monitor configuration file;
updating the synthetic monitor based on the one or more synthetic monitor provision elements;
receiving a request to enhance the one or more code elements;
enhancing the synthetic monitor configuration file in response to the request; and
creating an enhanced synthetic monitor in response to the enhancing, the enhanced synthetic monitor including one or more enhanced synthetic monitor code elements.

22. The computer readable medium of claim 21, wherein the enhanced synthetic monitor is configured to automatically monitor an application for ongoing compliance with a system requirement.

23. The computer readable medium of claim 21, wherein the enhanced synthetic monitor is configured to receive notice of an event indicative of an application error.

24. The computer readable medium of claim 23, wherein the application error is an application downtime.

25. The computer readable medium of claim 23, wherein the application error is a feature update request.

26. The computer readable medium of claim 21, wherein the synthetic monitor is associated with a plurality of applications based on a related subject matter of the plurality of applications.

27. The computer readable medium of claim 21, the operations further comprising:
identifying the enhanced synthetic monitor as capable of correcting an offender.

28. The computer readable medium of claim 27, wherein correcting the offender includes triggering a runbook tool.

29. A system comprising:
a memory storing instructions; and
a processor configured to execute the stored instructions to:
receive a synthetic monitor creation request including a synthetic monitor configuration file;
create a synthetic monitor in response to the request, the synthetic monitor associated with one or more code elements based on the synthetic monitor configuration file;
receive one or more synthetic monitor provision elements based on the synthetic monitor configuration file;
update the synthetic monitor based on the one or more synthetic monitor provision elements;
receive a request to enhance the one or more code elements;
enhance the synthetic monitor configuration file in response to the request; and
create an enhanced synthetic monitor in response to the enhancing, the enhanced synthetic monitor including one or more enhanced synthetic monitor code elements.

30. The system of claim 29, wherein the enhanced synthetic monitor is configured to automatically monitor an application for ongoing compliance with a system requirement.

31. The system of claim 29, wherein the enhanced synthetic monitor is configured to receive notice of an event indicative of an application error.

32. The system of claim 31, wherein the application error is an application downtime.

33. The system of claim 31, wherein the application error is a feature update request.

34. The system of claim 29, wherein the synthetic monitor is associated with a plurality of applications based on a related subject matter of the plurality of applications.

35. The system of claim 29, the processor is further configured to execute the instructions to:
identify the enhanced synthetic monitor as capable of correcting an offender.

36. The system of claim 35, wherein correcting the offender includes triggering a runbook tool.

37. A computer-implemented method comprising the following operations performed by one or more processors:
receiving a synthetic monitor creation request including a synthetic monitor configuration file;
creating a synthetic monitor in response to the request, the synthetic monitor associated with one or more code elements based on the synthetic monitor configuration file;
receiving one or more synthetic monitor provision elements based on the synthetic monitor configuration file;
updating the synthetic monitor based on the one or more synthetic monitor provision elements;
receiving a request to enhance the one or more code elements;
enhancing the synthetic monitor configuration file in response to the request; and
creating an enhanced synthetic monitor in response to the enhancing, the enhanced synthetic monitor including one or more enhanced synthetic monitor code elements.

38. The method of claim 37, wherein the enhanced synthetic monitor is configured to automatically monitor an application for ongoing compliance with a system requirement.

39. The method of claim 37, wherein the enhanced synthetic monitor is configured to receive notice of an event indicative of an application error.

40. The method of claim 37, wherein the synthetic monitor is associated with a plurality of applications based on a related subject matter of the plurality of applications.
